(19) United States
(12) Patent Application Publication
(10) Pub. No.: US 2020/0301304 A1
(43) Pub. Date: Sep. 24, 2020

(54) ELECTROPHORETIC INK

(71) Applicants: ARKEMA FRANCE, Colombes (FR); UNIVERSITÉ DE BORDEAUX, Bordeaux (FR); INSTITUT POLYTECHNIQUE DE BORDEAUX, Talence Cedex (FR); CENTRE NATIONAL DE LA RECHERCHE SCIENTIFIQUE, Paris (FR)

(72) Inventors: Deborah MIRBEL, Talence (FR); Christophe NAVARRO, Bayonne (FR); Cyril BROCHON, Mérignac (FR); Éric CLOUTET, Bégles (US); Georges HADZIIOANNOU, Léognan (FR)

(21) Appl. No.: 16/084,077

(22) PCT Filed: Mar. 3, 2017
(86) PCT No.: PCT/FR2017/050481

§ 371 Date: Sep. 11, 2018

(30) Foreign Application Priority Data
Mar. 11, 2016 (FR) 1652080

(51) Int. Cl. G03G 9/125; G03G 9/135

(52) U.S. Cl. CPC G03G 9/125; G03G 9/135

(57) ABSTRACT

Some embodiments relate to an electrophoretic ink including particles that may have a negative charge, dispersed in a non-polar organic solvent. The ink includes a trialkylamine charge-control agent, selected from the following charge-control agents: tributylamine, triisobutylamine, tripentylamine, trihexylamine, tri(2-ethylhexyl)amine, trioctylamine, triisooctylamine, tridodecylamine, triisododecylamine. The particles have a hydrophobic surface and an isoelectric point (IEP) or a point of zero charge (PZC) that is lower than the pKa of the charge-control agent.

### CROSS REFERENCE TO RELATED APPLICATIONS

This application is a national phase filing under 35 C.F.R. § 371 of and claims priority to PCT Patent Application No. PCT/FR2017/050481, filed on Mar. 3, 2017, which claims the priority benefit under 35 U.S.C. § 119 of French Patent Application No. 1652080, filed on Mar. 11, 2016, the contents of each of which are hereby incorporated in their entireties by reference.

### BACKGROUND

Some embodiments relate to inks for electrophoretic display devices, and more particularly to an ink including coloured particles that are dispersed in an apolar solvent and are negatively charged.

More specifically, some embodiments relate to an electrophoretic ink, to a process for manufacturing such an ink and to a display device using such an ink.

There are currently essentially two modes of information display. There are, on the one hand, electronic displays of liquid crystal LCD (acronym for “Liquid Crystal Display”) type or of plasma type for example, and, on the other hand, displays by printing on a paper support. Electronic displays have a big advantage since they are capable of rapidly updating displayed information and therefore of changing content, they are also said to be rewritable. This type of display is, however, complex to produce since the manufacturing thereof requires working in a clean room and high-tech electronics. It is consequently relatively expensive. Displays made by printing on a paper support, for their part, can be produced in bulk since they are very inexpensive, but do not allow information to be rewritten over the previous information. This type of display belongs to non-rewritable displays.

The idea of being able to combine the advantages of the two technologies arose a few years ago. A flexible display which can be manufactured at low cost and in great volume was produced. This display is the analogue of paper but in an electronic version, i.e. the information displayed on this support can be erased so as to rapidly leave room for another content. Furthermore, unlike the existing screens which need to usually have a power supply in order to be able to operate, electronic paper consumes only a very small amount of energy, only at the time the display changes. At a time when energy consumption is a major problem, having a flexible, reusable display device which mimics paper and consumes virtually no energy is a great opportunity. Furthermore, electronic paper is a reflective device, hence it affords a much increased reading comfort compared with screens with back-lighting which more considerably tire the eyes. This type of display is based on EPIDS (acronym for “ElectroPhoretic Image DisplayS”) technology. This technology consists in dispersing charged particles in a nonconductive medium between two parallel electrodes. More specifically, the display includes a conductive surface electrode, a cavity including pixels filled with electrophoretic ink, and a bottom electrode connected to transistors for controlling each pixel. The pixels can be produced in various ways. They can, for example, be produced by a grid which partitions the cavity into as many pixels as are desired for producing the display, or else they can be in the form of microcapsules, each microcapsule defining a pixel and being filled with the ink. The electrophoretic ink includes negatively and/or positively charged colored particles dispersed in an apolar solvent. The negatively charged particles have a colour different from the positively charged particles. When an electric field is applied, the negatively charged nanoparticles of each pixel will migrate to the positively charged electrode and vice versa. Thus, when an electric field is applied, the positively charged particles place themselves at one end of the pixel and the negatively charged particles at the other end, revealing the colour of one or other of the particles depending on their position relative to the surface of the display. Consequently, by placing millions of pixels in the cavity of the display and by controlling them with electric fields, by an electronic circuit intended to manage the displaying of the information, it is possible to generate a two-color image. One of the advantages of this type of display is that the contrast obtained depends directly on the migration of the particles and on the colour thereof. Furthermore, the display obtained is bistable since the image remains in place even once the electric field has been turned off.

In order to be able to render an ink electrophoretic, use is made of charge control agents, also denoted by CCA in the remainder of the description. The charge control agents generally used are ionic or nonionic surfactants that make it possible to positively or negatively charge particles, in an apolar medium, on the basis of the surface of these particles, i.e. according to their hydrophilic or hydrophobic nature and their acidic or basic property.

Document US 2003/0137717 discloses a related art electrophoretic display, including non-spherical capsules disposed in a single layer on a substrate, each capsule including mobile electrophoretic particles in suspension in a fluid and a charge control agent.

Among the nonionic surfactants used as charge control agents, mention may more particularly be made of the family of polyisobutylene succimides, which have the trade name “OLOA”, or else the family of sorbitan esters, which have the trade name “Span”. OLOAs are considered to be basic CCAs that will induce negative charges on the particles. Conversely, Spans are known to be acidic CCAs that induce positive charges at the surface of the particles.

Among the ionic surfactants, the most commonly used are Aerosol-OT (dioctyl sodium sulphosuccinate), also denoted by AOT, zirconyl 2-ethylhexanoate and hexadecyltrimethylammonium bromide (CTAB).

### SUMMARY

Document US2003/0137717 discloses such standard ionic and nonionic surfactants, used as charge control agents of particles in an apolar solvent.

However, on the basis of the nature of each particle, i.e. on the basis of its hydrophilic or hydrophobic nature or of its acidic or basic nature, the charge control agents used to date provide positive or negative charges that are difficult to predict. It is therefore very difficult to precisely control the positive or negative charge that a particle will have. Matthew Gacek et al., in the article entitled “Characterization of mineral oxide charging in apolar media” published in the journal Langmuir, 2012, pages 3032-3036, demonstrated a link between the acidity, or the basicity, of a particle, dispersed in Isopar-L, and the acidity, or the basicity, of the surfactant used, here AOT, with the polarity and the magnitude of the particle charge.

Furthermore, above a critical concentration of surfactant in the apolar medium, reverse micelles are formed which may screen the charge of the particles and induce an effect that is harmful for the display. Tina Lin et al., in the article entitled “Transport of charged colloids in a nonpolar solvent” published in the journal of the Royal Society of Chemistry, 2013, vol. 9, pages 5173-5177, thus demonstrated that in apolar solvents, AOT surfactants stabilize charges through the creation of reverse micelles, which enable the dissociation of charge from the surfaces of the particles, and make it possible to have charge-stabilizing particle suspensions. However, the presence of reverse micelles has a significant effect on particle mobility: in a constant field, the particles initially move, then slow down exponentially, and eventually stop. This phenomenon is explained by the accumulation of reverse micelles in the medium, which screen the applied electric field, leading to a decay of the internal electric field. The electrophoretic displays then have a very limited lifetime.

The Applicant has therefore searched for a solution to facilitate the charging of the particles in an apolar medium, so that it can be controlled precisely and without creating reverse micelles. For this, the Applicant is more particularly interested in the way of controlling the negative charge of a particle.

Some embodiments therefore address or overcome at least one of the drawbacks of the related art. Some embodiments are therefore directed to an electrophoretic ink including particles dispersed in an apolar solvent and a charge control agent suitable for charging these particles negatively, without inducing the appearance of reverse micelles capable of degrading the mobility of the particles.

Some embodiments are therefore directed to a process for manufacturing such an electrophoretic ink, which is easy and rapid to implement and which makes it possible to precisely control the charge of the particles, without inducing the formation of reverse micelles.

Some embodiments are therefore directed to an electrophoretic display device including such a link, that has a significantly increased lifetime compared to existing devices.

For this purpose, one embodiment is an electrophoretic ink including particles that may be negatively charged, dispersed in an apolar organic solvent, the ink including a charge control agent of trialkylamine type, chosen from the following charge control agents: tributylamine, triisobutylamine, tripentylamine, trihexylamine, tris(2-ethylhexyl)amine, trioctylamine, triisooctylamine, tridodecylamine, triisododecylamine, and in that the particles have a hydrophobic surface and an isoelectric point (IEP) or a point of zero charge (PZC) lower than the pKa of the charge control agent.

Thus, the trialkylamine-type charge control agent used, which is a strong base, makes it possible to provide more negative charges at the surface of the particles than the charge control agents used to date. The electrophoretic mobility of the particles thus charged is better than with the standard charge control agents, and does not decrease with time owing to the fact that no reverse micelle is formed in the apolar medium.

According to other features of the ink:
the charge control agent is advantageously or preferably a trialkylamine with carbon-based chains, the number of carbons of which is greater than 8;
the charge control agent is advantageously or preferably tridodecylamine;
the concentration of tridodecylamine in the apolar solvent is between 0.1 and 250 mmol/l, advantageously or preferably between 0.5 and 200 mmol/l, more advantageously or preferably between 1 and 100 mmol/l;
the particles are modified pigments or hybrid particles including a modified pigment and a surface polymer;
the hybrid particles are more particularly particles including a modified pigment core at the surface of which polymer particles have precipitated;
the pigments are modified by silanization with coupling agents chosen from methyltrimethoxysilane, ethyltrimethoxysilane, butyltrimethoxysilane, hexyltrimethoxysilane, octyltrimethoxysilane (OTS), decyltrimethoxysilane, dodecyltrimethoxysilane (DTS), hexadecyltrimethoxysilane or octadecyltrimethoxysilane; and advantageously or preferably OTS or DTS;
the grafting density of the alkyl chains, derived from the coupling agents, at the surface of the pigments is between 3 and 6 μmol/m²;
the degree of grafting of the alkyl chains derived from the coupling agents to the surface of the pigments is between 35% and 75%, advantageously or preferably between 50% and 70%,
the pigments are firstly covered with a silica shell, before their modification by silanization;
the apolar solvent is selected from at least one of the following solvents: hydrocarbon-based oils, halocarbon oils, or silicone oils;
the apolar solvent is a hydrocarbon-based oil, advantageously or preferably a paraffin oil, more advantageously or preferably Isopar G.

Some embodiments are directed to a process for manufacturing such an electrophoretic ink, including: synthesis of particles having a hydrophobic surface, the isoelectric point (IEP) or point of zero charge (PZC) of which is lower than the pKa of the charge control agent, dispersion of the synthesized particles in an apolar solvent, addition of the charge control agent to the apolar medium in order to negatively charge the hydrophobic particles, the one charge control agent being of trialkylamine type and chosen from the following charge control agents: tributylamine, triisobutylamine, tripentylamine, trihexylamine, tris(2-ethylhexyl)amine, trioctylamine, triisooctylamine, tridodecylamine, triisododecylamine.

Another embodiment is an electrophoretic display device including a plurality of cells filled with electrophoretic ink, each cell being in fluidic communication with its neighbour and defining a pixel, a surface electrode and a bottom electrode including a contact pad under each pixel, each pad being connected to a transistor of an integrated circuit intended for controlling the application of an electrostatic force to each pixel, the display device being characterized in that the electrophoretic ink is in accordance with that described above.

Finally, some embodiments are directed to the use of such an ink for producing such an electrophoretic display device.

### BRIEF DESCRIPTION OF THE FIGURES

Other advantages and features of some embodiments will appear on reading the following examples given by way of illustrative and nonlimiting example, with reference to the appended figures which represent:

FIG. 1, graphs of the electrophoretic mobility of various charged particles with standard charge control agents on the one hand and with tridodecylamine on the other hand;

FIG. 2, a graph of the electrophoretic mobility of a TiO₂@SiO₂—OTS modified hydrophobic pigment as a function of the concentration of tridodecylamine in the apolar solvent;

FIG. 3, a graph of the electrophoretic mobility of a Fe₂O₃-OTS modified hydrophobic pigment as a function of the concentration of tridodecylamine in the apolar solvent;

FIG. 4, a graph of the electrophoretic mobility of a hydrophobic hybrid particle, including, at the core, a Fe₂O₃-OTS modified pigment and, at the surface, particles of poly(4-vinyl pyridine-co-lauryl acrylate) polymer, as a function of the concentration of tridodecylamine in the apolar solvent;

FIG. 5, a graph of the surface tension of a drop of deionized water in Isopar-G measured at various concentrations of tridodecylamine in the medium in order to determine the critical micelle concentration CMC of tridodecylamine in the apolar medium.

### DETAILED DESCRIPTION OF EXEMPLARY EMBODIMENTS

As a preamble, it is specified that the expressions “between” and/or “less than” and/or “greater than” used within the context of this description should be understood as including the limits mentioned.

The expression “point of zero charge” (acronym “PZC”) denotes the pH of a dispersion in which the charge density at the surface of the particles of the dispersion is equal to zero. The PZC characterizes the acidic or basic property of a particle. Similarly, the term “isoelectric point” (IEP) itself also denotes the pH of a dispersion in which the charge density at the surface of the particles of the dispersion is equal to zero. The IEP itself also characterizes the acidic or basic property of a particle. The difference between the PZC and the IEP is based on the phenomenon of specific adsorption. Thus, if the quantity measured does not depend on the solution used for measuring it (pH, concentration, nature of the ions), then it is a PZC. In the opposite case, it is an IEP that is measured.

Irrespective of the value measured, IEP or PZC of the particles, it is measured in water by varying the pH of the solution using a Malvern Nano ZS cell. More specifically, at each pH of the solution, the electrophoretic mobility of the particles is measured. The IEP, or the PZC, corresponds to the pH at which the electrophoretic mobility of the particles is zero.

The IEP or PZC measurements were carried out on unmodified pigments. The alkyl chains, originating from the OTS or DTS coupling agents used for modifying the surface of the pigments in order to render it hydrophobic, are neutral and do not vary the value of the IEP or PZC.

A “dispersion” is understood to mean a colloidal system having a continuous liquid phase and a discontinuous second phase that is distributed throughout the continuous phase.

The formulation of the electrophoretic ink according to some embodiments advantageously includes chargeable particles, dispersed in an apolar organic solvent, and a charge control agent of trialkylamine type, chosen from the following charge control agents: tributylamine, triisobutylamine, tripentylamine, trihexylamine, tris(2-ethylhexyl)amine, trioctylamine, triisooctylamine, tridodecylamine, triisododecylamine. Advantageously or preferably, this charge control agent is a trialkylamine with carbon-based chains, the number of carbons of which is greater than 8. More advantageously or preferably still, the charge control agent is tridodecylamine, also denoted by Dod₃N in the remainder of the description. The chargeable particles are particles having an IEP or PZC lower than the pKa of the charge control agent used and having a hydrophobic surface.

### Regarding the Charge Control Agent

Tridodecylamine is a strong organic base, the pKa of which is equal to 10.83. This amine reacts, by acid-base reaction, with hydroxyl groups present at the surface of the particles. Pairs of ions are then created with, on the one hand, a metal alcoholate for example, if the particle is a metal oxide, and an ammonium countercation on the other hand, soluble in the apolar solvent. In an apolar medium, the dissociated charges provide greater electrostatic forces than in a polar medium. A tiny portion of these pairs of ions dissociating in the apolar medium is then sufficient to make it possible to induce negative charges at the surface of the particles and thus render them electrophoretic. Typically, the dissociation of one pair of ions out of 1000 million pairs of ions is sufficient to negatively charge the particles. The article entitled “Charge Generation in Low-Polarity Solvents: Poly(ionic liquid)-Functionalized Particles”, published in the journal Langmuir, 2013, 29(13), p. 4204-4213, Hussain, G., A. Robinson, and P. Bartlett; describes such a dissociation of an ionic species, to give a [Dod₄]N⁺ quaternary amine on the one hand and a [TPhB]⁻ borate counteranion on the other hand, in an apolar medium.

Too low a concentration of Dod₃N in the apolar solvent does not make it possible to correctly charge the particles and too high a concentration risks leading to the formation of reverse micelles, which it is precisely desired to avoid. Advantageously, the concentration of tridodecylamine in the apolar solvent is between 0.1 and 250 mmol/l, advantageously or preferably between 0.5 and 150 mmol/l, and more advantageously or preferably between 1 and 100 mmol/l.

### Regarding the Particles

The particles suitable for being negatively charged are acidic or basic particles, which have an isoelectric point IEP or point of zero charge PZC lower than the pKa (of 10.8) of tridodecylamine, and having a hydrophobic surface. They have a size of between 250 nm and 2 μm. They are chosen from any colored particle, which has hydroxyl groups at its surface and which is more acidic than tridodecylamine.

Thus, the particles may be chosen from inorganic particles, such as modified inorganic pigments for example or from hybrid particles including a modified inorganic pigment at the core and polymer particles at the surface.

The inorganic pigments may for example be chosen from metal oxides.

The more acidic the pigments are with respect to tridodecylamine, the more they can be negatively charged, and the more negatively charged they are, the greater their electrophoretic mobility.

When the inorganic pigments do not have a sufficient acidity, it is possible to adjust the acid-based interactions at the surface of the pigments by covering them with a silica shell, leading to “core-shell” type pigments being obtained, which are stable in an apolar organic medium and which have acidic properties.

When the inorganic pigments have a weakly hydrophobic or hydrophilic surface, they may advantageously be modified, by silanization, in order to render their surface hydrophobic. For this, coupling agents, chosen from methyltrimethoxysilane, ethyltrimethoxysilane, butyltrimethoxysilane, hexyltrimethoxysilane, octyltrimethoxysilane (OTS), decyltrimethoxysilane, dodecyltrimethoxysilane (DTS), hexadecyltrimethoxysilane or lastly octadecyltrimethoxysilane, are grafted to the surface of the particles. Advantageously or preferably, the coupling agents are octyltrimethoxysilane (OTS) or dodecyltrimethoxysilane (DTS). The degree of grafting of the alkyl groups, derived from these coupling agents, to the surface of the inorganic particles, makes it possible to quantify the transfer of hydrophobicity to the surface of the particles.

The degree of grafting is determined from elemental analysis of the carbon on the unmodified inorganic pigment and on the inorganic pigment silanized by OTS or DTS coupling agents. More particularly, the degree of grafting N is determined from the following formula:

$$N ( μmol . {m}^{- 2} ) = \frac{C ( \% ) {m}_{part .}}{100 \times 12 \times {N}_{C}} \times \frac{1 {0}^{6}}{{S}_{part .}} ,$$

in which C (%) is the carbon content of the modified pigment, determined by elemental analysis of the carbon, Sₚₐᵣₜ is the surface area of the modified pigment (m²), determined from the diameter of the pigment by electron microscopy, mₚₐᵣₜ (g) is the mass of the particle, determined from the density and from the size of the pigment. N_{c} is the number of carbon atoms forming the OTS or DTS groups. The diameter of the hydrophilic pigment is considered to be identical to that of the modified pigment. Indeed, the OTS and DTS groups are assumed not to affect the diameter of the pigment due to their size (of 10 Å), which is negligible with respect to the diameters of the particles that range from 117 to 210 nm depending on the nature thereof.

Thus, the grafting density of the alkyl chains derived from the OTS and DTS groups at the surface of the pigments was determined and is between 3 and 6 μmol/m². Starting from the principle that the number of hydroxyl groups in the initial state, at the surface of the unmodified pigments, is 8 μmol/m², as described in the article entitled “Encapsulation of Inorganic Particles by Dispersion Polymerization in Polar Media: 1. Silica Nanoparticles Encapsulated by Polystyrene”, Bourgeat-Lami, E. and J. Lang, Journal of Colloid and Interface Science, 1998. 197(2): p. 293-308, a degree of grafting of between 35% and 75%, advantageously or preferably between 50% and 70% is obtained.

The size of the pigments before and after modification was also measured by the dynamic light scattering (DLS) technique. Before modification, the pigments are hydrophilic and aggregated. After modification, the pigments become hydrophobic and their size is of the order of a micrometre. The surface modification of the pigments by OTS or DTS groups therefore improves the dispersion of the particles in the apolar medium. The addition of tridodecylamine makes it possible, by electrostatic repulsion, to further reduce the size of the particles to between 300 and 600 nm, thus improving the dispersion of the particles in the medium.

The chargeable particles may also be hybrid particles, including a core including or consisting of inorganic pigment and a polymer surface. These hybrid particles may for example have morphologies of raspberry type or else core-crown type. These hybrid particles are stable in an apolar organic medium. They are synthesized by dispersion polymerization in an apolar medium using a macroinitiator. The polymer thus formed at the surface of the inorganic pigment makes it possible to reduce the density of the hybrid particles and promotes the dispersion thereof. This polymer surface is synthesized from functional monomers that may be chosen from 4-vinylpyridine or an acrylic or methacrylic acid and derivatives thereof, optionally copolymerized with another neutral monomer such as styrene or MMA (methyl methacrylate) for example.

### Regarding the Apolar Solvent

The apolar solvent is advantageously chosen from liquid alkanes, liquid haloalkanes, or else liquid silicones. More particularly, it is chosen from halocarbon oils, hydrocarbon-based oils or silicone oils.

Among the halocarbon oils, mention may for example be made of chlorotrifluoroethylene, sold under the references “halocarbon 1.8” or “halocarbon 0.8”, or else tetrafluorodibromoethylene, tetrachloroethylene, 1,2,4-trichlorobenzene, or else tetrachloromethane.

Among the hydrocarbon-based oils, mention may for example be made of paraffin oils, heptane, dodecane, tetradecane, etc.

Among the silicone oils, mention may for example be made of the fluid silicone oils sold by Dow Corning under the reference DOW 200, or else octamethylcyclosiloxane, poly(methylphenylsiloxane), hexamethyldisiloxane or polydimethylsiloxane.

Advantageously or preferably, the apolar solvent is chosen from hydrocarbon-based oils, and preferentially from paraffin oils. More advantageously or preferably, the apolar solvent is chosen from the paraffin oils manufactured and sold by Exxon under the commercial reference Isopar, and more particularly the oil sold under the reference Isopar G.

### EXAMPLES

### Example 1: Synthesis of Coloured Particles Capable of being Negatively Charged

### a) Modified Inorganic Pigments

Various particles were synthesized in order to be compared with one another.

The inorganic pigments used are metal oxides, more particularly titanium dioxide TiO₂ and ferric oxide Fe₂O₃.

The isoelectric points IEP of these two unmodified pigments were measured respectively at 7.6 and 8.4, expressing their basic nature. The isoelectric point of the unmodified pigments was measured in water with a Malvern Nano ZS cell while varying the pH of the solution. More specifically, at each pH, the electrophoretic mobility of the particles was measured. The IEP corresponds to the pH at which the electrophoretic mobility of the particles is zero.

In order to regulate the acid-base interactions at the surface of these pigments, they are covered with a silica shell. Core-shell type particles of TiO₂@SiO₂ were thus synthesized. The synthesis of the SiO₂ shell is carried out by following the process developed by Stöber W., A. Fink, and E. Bohn and described in the document entitled “Controlled growth of monodisperse silica spheres in the micron size range”, Journal of Colloid and Interface Science, 1968. 26(1): p. 62-69. The isoelectric point was measured for these particles at 3.10, expressing their acidic nature.

Since these pigments are pigments with a hydrophilic surface, they were modified by silanization carried out with octyltrimethoxysilane (OTS) or dodecyltrimethoxysilane (DTS). For this, the hydrophilic pigment is mixed with toluene, in an amount of 50 g/l and 3.86 mmol of OTS (0.907 mg), or 3.06 mmol of DTS (0.89 mg), then heated under reflux for 15 h. The pigments are subsequently washed by cycles of centrifugation/redispersion in toluene and then dried in the oven at 50° C. under vacuum.

Another method of silanization may be to carry out this modification in bulk by introducing the pigment directly into a solution of OTS or DTS (in an amount of 50 g/l).

Irrespective of the method used, the degree of grafting is of the same order of magnitude. The grafting density of the alkyl groups, derived from the coupling agents, at the surface of the inorganic particles was determined from the elemental analysis of the carbon on the unmodified and modified pigments, and as described above. The greater the grafting density, the more the particle has a hydrophobic surface. The particles thus modified are denoted by TiO₂-OTS, TiO₂-DTS, Fe₂O₃-OTS or Fe₂O₃-DTS or else TiO₂@SiO₂—OTS and TiO₂@SiO₂-DTS when they are firstly covered with a silica shell.

Through these coupling agents, the grafting density of the alkyl chains derived from the OTS and DTS groups, at the surface of the pigments, is between 3 and 6 μmol/m². Such a density corresponds to a degree of between 35% and 75%, advantageously or preferably between 50% and 70%. The surface of the pigments is then rendered hydrophobic, and the higher the degree of grafting, the higher the hydrophobicity too. Hydroxyl groups remain however available at the surface of the pigments to enable the acid-base reaction with Dod₃N and to thus enable the negative charging of the pigments.

### b) Hybrid Particles

In order to synthesize hybrid particles, including an inorganic pigment at the core and polymer particles at the surface, a first step consists in synthesizing a macroinitiator. This macroinitiator will enable not only the polymerization of the polymer particles around the pigment, but also the stabilisation of the particles in the apolar organic medium and the control of their sizes so that they are all homogeneous.

A macroinitiator denotes an additive composed of a hydrophobic polymer chain, used for the stabilisation of the particles, and of an initiating portion which is used for starting the polymerization reaction and ultimately leads to the formation of a copolymer. The macroinitiator is advantageously synthesized by nitroxide-controlled free radical polymerization with an initiator manufactured and sold by Arkema under the “Blocbuilder®” brand. After the initiation of the polymerization reaction on the macroinitiator, an amphiphilic copolymer is formed with a (stabilizing) hydrophobic block and a hydrophilic block which, via its precipitation, will be the source of nuclei. The latter will then, during the synthesis, coalesce and form particles. Thus, the hydrophobic polymer chains of the macroinitiator remain connected to the particles and may thus stabilize them in the apolar organic medium.

In order to synthesize the hybrid particles, by dispersion polymerization in an apolar medium, use is made of the macroinitiator, poly(lauryl acrylate), synthesized by nitroxide-controlled free radical polymerization with an initiator manufactured and sold by Arkema under the “Blocbuilder®” brand, in toluene. Once the macroinitiator has been synthesized and purified, it is mixed in the apolar solvent, for example Isopar-G, with a hydrophilic monomer, for example chosen from 4-vinylpyridine, acrylic acid or methyl methacrylate for example, and the modified pigment, so as to synthesize the hybrid particles including a modified pigment core at the surface of which polymer particles have precipitated.

For this, 3 g of modified pigment (Fe₂O₃-OTS) are mixed with 3 g of macroinitiator, poly(lauryl acrylate), in 90 ml of Isopar-G. The macroinitiator assists with the stabilization of the pigment particles in the apolar solvent. This solution is mixed in an ultrasonic bath using an ultrasonic probe. It is then poured into a mechanically stirred reactor. 10 g of functional monomers, 4-vinyl pyridine, are then added along with 1.5 g of macroinitiator in order to initiate the reaction. The solution is then degassed under nitrogen for 1 hour, then heated at 120° C., with mechanical stirring at 300 rpm for 15 hours. Once synthesized, the (Fe₂O₃-OTS/Poly(4-VP-co-LA) particles obtained are washed by centrifugation and redispersion in Isopar-G.

### Example 2: Formulation of the Electrophoretic Ink

The particles synthesized, whether they are in the form of modified pigments or hybrid particles, are dispersed in Isopar G. Next, between 1 and 100 mmol/1 of tridodecylamine are added in order to negatively charge the particles.

An ink is thus synthesized for each particle.

The electrophoretic mobility of the electrophoretic particles of the inks thus synthesized is measured by the PALS (acronym for “Phase Analysis Light Scattering”) technique using a Malvern Nano ZS cell designed for an apolar medium. A square-wave signal ranging from 2.5 to 20 kV/m is applied to the cell. This technique consists in measuring the phase shift between the incident wave and the wave reflected by a mobile electrophoretic particle in dispersion. The ink samples analyzed include 0.005% by weight of particles in Isopar G.

Since tridodecylamine is a strong base, with a pKa equal to 10.83, it provides more negative charges at the surface of the particles than the known charge control agents, of OLOA type for example. Thus, the electrophoretic mobility of the particles charged with tridodecylamine is higher (as an absolute value) than those which have been charged with OLOA 11000, Span 80 and AOT.

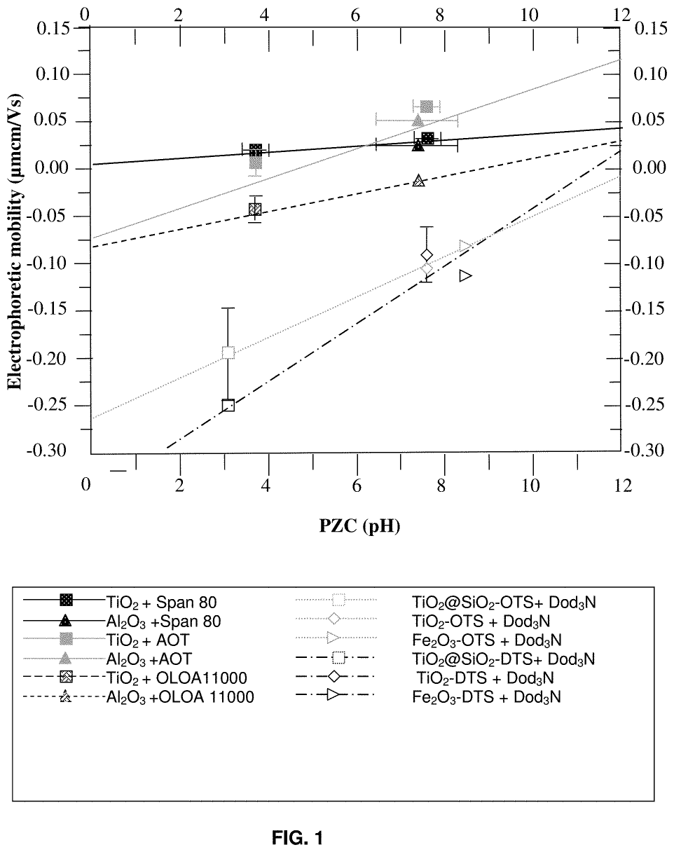

FIG. 1 illustrates this electrophoretic mobility of the charged hydrophilic particles with, on the one hand, particles charged with Span 80, OLOA 11000 and AOT and, on the other hand, hydrophobic particles charged with Dod₃N (at a concentration of 16 mmol/1 in Isopar G). In this figure, the highest electrophoretic mobility of a particle, as an absolute value, is plotted as a function of its point of zero charge PZC. Thus, for example, the TiO₂-OTS hydrophobic pigment charged with Dod₃N has a PZC of 7.6 and an electrophoretic mobility of −0.10 μmcm/Vs when 16 mmol/1 of tridodecylamine are added to Isopar G.

In this FIG. 1, it is observed that the hydrophilic pigment particles, represented by solid symbols, do not have a very high electrophoretic mobility, at most of the order of 0.075 μmcm/Vs as an absolute value. The hydrophobic modified pigments, represented by open symbols in FIG. 1, and negatively charged with Dod₃N (at a concentration of 16 mmol/1 in Isopar G), have a higher electrophoretic mobility, typically between 0.27 and 0.10 μmcm/Vs as an absolute value.

In comparison, in the article entitled “Effect of alkyl functionalization on charging of colloidal silica in apolar media”, Journal of Colloid and Interface Science 351 (2010) p. 415-420, Saran Poovarodom, Sathin Poovarodom and John C. Berg studied the electrophoretic mobility of silica particles, the surface of which was modified by hexadecyltrimethoxysilane to render it hydrophobic, in Isopar-L and negatively charged with various standard charge control agents chosen from AOT, OLOA 11000 and zirconyl 2-ethyl hexanoate (ZrO(oct)₂). This article states that the modified silica particles, with a hydrophobic surface, have a higher electrophoretic mobility, as an absolute value, than the mobility of the same unmodified particles. However, irrespective of the charge control agent used from among the standard charge control agents for charging these particles, the electrophoretic mobility of the hydrophobic particles remains much lower than that measured when the particles are charged with tridodecylamine. Indeed, the electrophoretic mobility measured on particles charged with standard CCAs varies, as an absolute value, between 0.01 and 0.062 μmcm/Vs depending on the charge control agents used, whereas it is between 0.1 and 0.4 μmcm/Vs with Dod₃N.

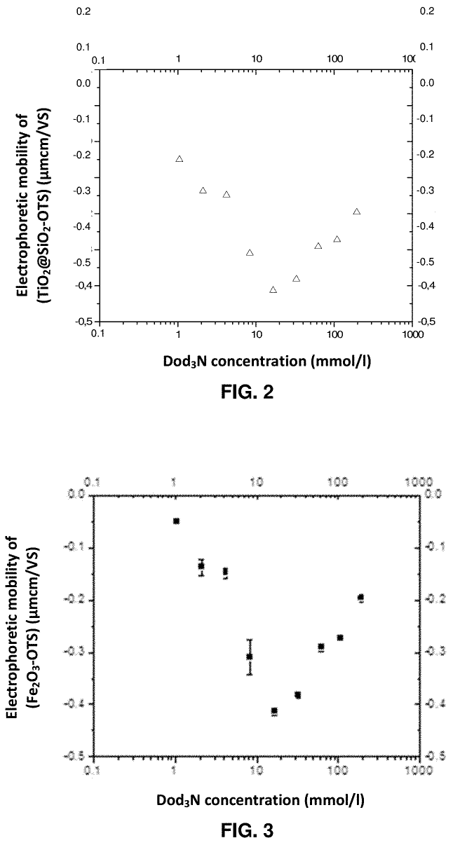

The mobility of each hydrophobic particle was also measured as a function of the concentration of tridodecylamine in the apolar solvent. FIG. 2 thus represents the graph of the electrophoretic mobility of the TiO₂@SiO₂—OTS modified pigment as a function of the concentration of Dod₃N in Isopar-G. It turns out that the mobility of this pigment is maximum, as an absolute value, with a concentration of Dod₃N in Isopar-G of 16 mmol/l. In this case, the maximum mobility is equal to −0.38 μmcm/Vs.

Similarly, FIG. 3 represents the graph of the electrophoretic mobility of the Fe₂O₃-OTS modified pigment as a function of the concentration of Dod₃N in Isopar-G. It turns out that the mobility of this pigment is maximum, as an absolute value, with a concentration of Dod₃N in Isopar-G of 16 mmol/l. In this case, the maximum mobility is equal to −0.33 μmcm/Vs.

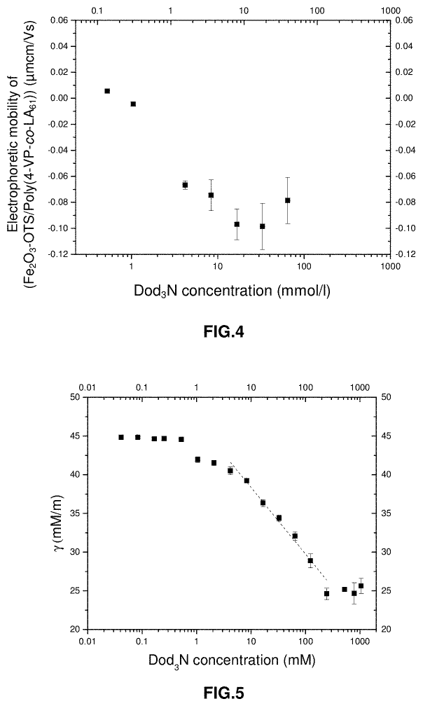

FIG. 4 represents the graph of the electrophoretic mobility of an Fe₂O₃-OTS hybrid particle with, at the surface, poly(4-vinylpyridine-co-lauryl acrylate) polymer particles, as a function of the concentration of Dod₃N in Isopar-G. It turns out that the mobility of this pigment is maximum, as an absolute value, with a concentration of Dod₃N in Isopar-G of 32 mmol/l. In this case, the maximum mobility is equal to −0.11 μmcm/Vs.

Generally, the maximum mobility, as an absolute value, for each of the hydrophobic particles analyzed, was measured for a concentration of tridodecylamine of between 8 and 32 mmol/1 in Isopar G.

Tridodecylamine therefore makes it possible to negatively charge particles, the isoelectric point (IEP) or point of zero charge (PZC) of which is lower than the pKa of tridodecylamine and the surface of which is hydrophobic, and to obtain electrophoretic particles having a better electrophoretic mobility than with the standard charge control agents. Since the concentration of tridodecylamine in the ink is lower than the critical micelle concentration CMC, which was determined at 250 mmol/l, the electrophoretic ink obtained has no reverse micelle capable of degrading the mobility of the particles over time. The display devices including such an ink therefore have a significantly increased lifetime.

The CMC was determined by measuring the surface tension of a drop of deionized water, in Isopar-G, by the pendant drop method, at various concentrations of tridodecylamine in the apolar medium, using a Kruss FM3200 tensiometer. Each surface tension value plotted on the graph from FIG. 5 corresponds to an average of five measurements.

1. An electrophoretic ink, comprising:
particles configurable to be negatively charged, dispersed in an apolar organic solvent; and
a charge control agent of trialkylamine type, chosen from the following charge control agents: tributylamine, triisobutylamine, tripentylamine, trihexylamine, tris(2-ethylhexyl)amine, trioctylamine, triisooctylamine, tridodecylamine, triisododecylamine,
wherein the particles have a hydrophobic surface and an isoelectric point (IEP) or a point of zero charge (PZC) lower than the pKa of the charge control agent.

2. The ink according to claim 1, wherein the charge control agent is a trialkylamine with carbon-based chains, the number of carbons of which is greater than 8.

3. The ink according to claim 1, wherein the charge control agent is tridodecylamine.

4. The ink according to claim 3, wherein the concentration of tridodecylamine in the apolar solvent is between 0.1 and 250 mmol/l.

5. The ink according to claim 1, wherein the particles are modified pigments or hybrid particles including a modified pigment and a surface polymer.

6. The ink according to claim 5, wherein the hybrid particles are more particularly particles including a modified pigment core at the surface of which polymer particles have precipitated.

7. The ink according to claim 5, wherein the pigments are modified by silanization with coupling agents chosen from methyltrimethoxysilane, ethyltrimethoxysilane, butyltrimethoxysilane, hexyltrimethoxysilane, octyltrimethoxysilane (OTS), decyltrimethoxysilane, dodecyltrimethoxysilane (DTS), hexadecyltrimethoxysilane or octadecyltrimethoxysilane; and preferably OTS or DTS.

8. The ink according to claim 7, wherein the grafting density of the alkyl chains, derived from the coupling agents, at the surface of the pigments is between 3 and 6 mol/m².

9. The ink according to claim 5, wherein the pigments are firstly covered with a silica shell, before their modification by silanization.

10. The ink according to claim 1, wherein the apolar solvent is selected from at least one of the following solvents: hydrocarbon-based oils, halocarbon oils, or silicone oils.

11. The ink according to claim 10, wherein the apolar solvent is a hydrocarbon-based oil.

12. A process for manufacturing the electrophoretic ink according to claim 1, comprising:
synthesizing particles having a hydrophobic surface, the isoelectric point (IEP) or point of zero charge (PZC) of which is lower than the pKa of the charge control agent,
dispersing the synthesized particles in an apolar solvent,
adding the charge control agent to the apolar medium in order to negatively charge the hydrophobic particles, the one charge control agent being of trialkylamine type and chosen from the following charge control agents: tributylamine, triisobutylamine, tripentylamine, trihexylamine, tris(2-ethylhexyl)amine, trioctylamine, triisooctylamine, tridodecylamine, triisododecylamine.

13. An electrophoretic display device, comprising:
the electrophoretic ink of claim 1;
an integrated current having a transistor;
a plurality of cells filled with the electrophoretic ink, each cell being in fluidic communication with its neighbour and defining a pixel;
a surface electrode and a bottom electrode including a contact pad under each pixel, each pad being connected to the transistor of the integrated circuit configured for controlling the application of an electrostatic force to each pixel.

14. (canceled)

15. The ink according to claim 3, wherein the concentration of tridodecylamine in the apolar solvent is between 1 and 100 mmol/l.

16. A process for manufacturing the electrophoretic ink according to claim 2, comprising:
synthesizing particles having a hydrophobic surface, the isoelectric point (IEP) or point of zero charge (PZC) of which is lower than the pKa of the charge control agent,
dispersing the synthesized particles in an apolar solvent,
adding the charge control agent to the apolar medium in order to negatively charge the hydrophobic particles, the one charge control agent being of trialkylamine type and chosen from the following charge control agents: tributylamine, triisobutylamine, tripentylamine, trihexylamine, tris(2-ethylhexyl)amine, trioctylamine, triisooctylamine, tridodecylamine, triisododecylamine.

17. The ink according to claim 3, wherein the particles are modified pigments or hybrid particles including a modified pigment and a surface polymer.

18. The ink according to claim 4, wherein the particles are modified pigments or hybrid particles including a modified pigment and a surface polymer.

19. The ink according to claim 6, wherein the pigments are modified by silanization with coupling agents chosen from methyltrimethoxysilane, ethyltrimethoxysilane, butyltrimethoxysilane, hexyltrimethoxysilane, octyltrimethoxysilane (OTS), decyltrimethoxysilane, dodecyltrimethoxysilane (DTS), hexadecyltrimethoxysilane or octadecyltrimethoxysilane; and preferably OTS or DTS.

20. The ink according to claim 6, wherein the grafting density of the alkyl chains, derived from the coupling agents, at the surface of the pigments is between 3 and 6 μmol/m².

21. The ink according to claim 10, wherein the apolar solvent is a paraffin oil.
